(19) United States
(12) Patent Application Publication
(10) Pub. No.: US 2019/0005042 A1
(43) Pub. Date: Jan. 3, 2019

(54) METHOD AND APPARATUS FOR PROVIDING A RECOMMENDATION BASED ON THE PRESENCE OF ANOTHER USER

(71) Applicant: THOMSON Licensing, Issy- les Moulineaux (FR)

(72) Inventors: Akshay PUSHPARAJA, Sunnyvale, CA (US); Ivonete MARKMAN, Carmel, IN (US)

(21) Appl. No.: 16/065,105

(22) PCT Filed: Dec. 22, 2015
(86) PCT No.: PCT/US2015/067352

§ 371 Date: Jun. 21, 2018

(51) Int. Cl. G06F 17/30; H04M 1/725; G06F 3/01

(52) U.S. Cl. CPC G06F 17/30035; G06F 3/011; H04M 1/72569

(57) ABSTRACT

Efficient techniques are provided for ensuring the privacy of users while receiving recommendations in the presence of others, or when other people besides the user are receiving the recommendations while using the user's device. The presence of other people is determined based on data from at least one sensor. A recommendation is provided based on the determined presence of the other people. If no other person besides the user is determined to be present, a personalized recommendation may be provided. If, however, another person besides the user is determined to be present, an alternative recommendation such as a generic or an obscured recommendation may be provided. The alternative recommendation may be customized and/or pre-selected by the user. A method (300), apparatus (400, 260-1, 205), computer-readable storage medium and non-transitory computer-readable program product are provided for providing a recommendation.

### TECHNICAL FIELD

The present disclosure relates to recommendation apparatuses and methods.

### BACKGROUND

Many different multimedia streaming, or downloading services, or websites are available to consumers today. For example, services such as Netflix, Amazon, Hulu and MGO allow a user to watch different multimedia programs on different user devices. As is well known in the art, a multimedia program is a program which has content in more than one component or form, such as, for example, a movie or a television show which have both a video component and an audio component. Some of the movies and television shows also have another component, such as a text component comprising closed captioned text.

All of the content services mentioned above would allow a user to rate a program. The feedback ratings of the multimedia programs provided by the individual users are typically used by the content services to recommend other programs which may be of interest to the users of these content services. The content services may also recommend other multimedia programs to the users based on the viewing history of the users.

More generally, a great deal of research and commercial activity in the last decade has led to the wide-spread use of recommendation systems in a variety of online environments. Recommendation or recommender systems are a subclass of information filtering systems that seek to predict the rating or preference that a user would give to an item. Such systems offer users generic or personalized recommendations for many kinds of items, such as movies, TV shows, music, books, hotels, restaurants, search queries, social tags, products in general, financial services, life insurance, dating, and more.

Recommender systems typically produce a list of recommendations in one of two ways: through collaborative or content-based filtering. Collaborative filtering approaches build a model from a user's past behavior (e.g., items previously purchased or selected and/or numerical ratings given to those items) as well as similar decisions made by other users. This model is then used to predict items (or ratings for items) that the user may have an interest in. Content-based filtering approaches utilize a series of discrete characteristics of an item in order to recommend additional items with similar properties. These approaches are often combined in Hybrid Recommender Systems. A recommender may be, for example, a Video on Demand (VOD) service provider as mentioned above, a social network provider (e.g., Facebook or Twitter), an internet search engine provider (e.g., Google or Bing), an online sales company (e.g., Amazon or Overstock), a phone, cable television or internet service provider (e.g., Comcast or Verizon), etc. The ubiquitous use of recommendations, however, has created problems related with the privacy of the users that provide information to recommenders and/or receive recommendations.

In order to receive useful recommendations, users need to supply substantial personal information about their preferences (users' inputs), trusting that the recommender will manage this data appropriately. In addition, a large number of services are offered for free (e.g., social networks, email accounts, product discounts or coupons, memberships, etc.) with the idea that the user's personal information can be accessed by the service provider for the purpose of recommendation. Furthermore, recommenders are often motivated to resell data for a profit, and also to extract information beyond what is intentionally revealed by the user. For example, even records of user preferences typically not perceived as sensitive, such as movie ratings or a person's TV viewing history, may be used to infer a user's political affiliation, gender, etc. The private information about the users that may be inferred from the data in a recommendation system is constantly evolving as new data mining and inference methods are developed, for either malicious or benign purposes. In the extreme, records of user preferences may be used to even uniquely identify a user: A. Naranyan and V. Shmatikov strikingly demonstrated this by de-anonymizing the Netflix dataset in “Robust de-anonymization of large sparse datasets”, Proceedings of 2008 IEEE Symposium on Security and Privacy.

It is therefore of interest to provide efficient techniques for ensuring the privacy of users. The present disclosure is directed towards such a technique.

### SUMMARY

According to one aspect of the present disclosure, a method is provided, the method including receiving data from at least one sensor, determining a presence of at least one person other than a user of a user device based on the data, and providing a recommendation for the user based on the determined presence.

According to another aspect of the present disclosure, an apparatus is provided, the apparatus including a processor in communication with at least one input/output interface, at least one memory in communication with the processor, the processor being configured to receive data from at least one sensor, determine a presence of at least one person other than a user of a user device based on the data, and provide a recommendation for the user based on the determined presence.

Additional features and advantages of the present disclosure will be made apparent from the following detailed description of illustrative embodiments which proceeds with reference to the accompanying figures.

### BRIEF DESCRIPTION OF THE DRAWINGS

The present disclosure may be better understood in accordance with the following exemplary figures briefly described below:

FIG. 1 illustrates an exemplary system according to the present disclosure;

FIG. 2 illustrates another exemplary system according to the present disclosure; and

FIG. 3 illustrates a flowchart of an exemplary method according to the present disclosure.

FIG. 4 illustrates a block diagram of a computing environment within which aspects of the present disclosure can be implemented and executed.

### DETAILED DISCUSSION OF THE EMBODIMENTS

The present disclosure recognizes that, as the data mining and inference methods become more and more refined, the more personalized recommendations become. A problem then appears associated with the viewing of personalized recommendations by a user in a public place, or even in a private place when in the presence of others (e.g., family, friends, co-workers, etc.). Therefore, the user may not wish for the personalized recommendations to be viewed by others but may still want to utilize his or her device in situations where recommendations may be provided (e.g., browsing the web, social networking, buying products online, etc.)

Another problem recognized by the present disclosure is, e.g., associated with when someone else other than the user borrows the user's device (with or without the user's consent) to perform activities like, for example, browsing the internet. Recommenders may not be able to recognize another person using the device and the user may not want another person or persons to receive personalized recommendations directed to the user when the other person or persons are using the device and/or are in the proximity of the user's device.

According to the present disclosure, it is therefore of interest to provide efficient techniques for ensuring the privacy of users while receiving recommendations in the presence of others, or when other people besides the user are receiving the recommendations while using the user's device. The present disclosure is directed towards such solutions to solve such recognized problems.

Therefore, the present disclosure provides recommendation methods and apparatuses which take into account whether at least another person besides the owner or the user of a user device is present when a recommendation is being provided to the user on the user device. According to an exemplary embodiment of the present disclosure, a sensor is provided to detect the presence of at least another person besides the user of a user device. A recommendation is made based on the determined presence of at least another person. If no other person besides the user is determined to be present, a personalized recommendation is displayed as usual. If however, at least another person besides the user is determined to be present, an alternative recommendation is displayed instead. The alternative recommendation may be, e.g., a generic recommendation or a recommendation that is obscured. In one exemplary embodiment, the alternative recommendation may be customized and/or pre-selected by the user. For example, the customization may include creating the user's own alternative recommendation. The pre-selection may include the choice of an alternative recommendation among several options.

As used herewith, a personalized recommendation is a recommendation which takes into consideration the personal preferences and/or information from the user. On the other hand, an alternative to the personalized recommendation is a generic recommendation or a recommendation which is obscured in some other way. A generic recommendation is a general recommendation, reflective of, e.g., a group of people, instead of just specific to an individual user. In the present disclosure, generic recommendations are used in order to de-personalize the personal recommendations when other people are also present.

An obscured recommendation may include a generic recommendation. In addition, in order to provide an alternative recommendation, the personalized recommendation may be obscured in some other way. For example, a user may be provided with an indication that the alternative recommendation is being provided instead of the usual personalized recommendation. In one exemplary embodiment, a user may receive a notification in the form of an image of a box for the alternative recommendation. The box may be in any color, but it would represent a known image to the user which would allow the user to recognize that an obscuring is taking place. In another non-limiting exemplary embodiment, the notification may be a known statement in text, or a Uniform Resource Locator (URL) link to a website where the personalized recommendation may be seen. In another exemplary embodiment, the obscuring notification may be in an audio format. For example, the audio indication may be a song excerpt or another type of audio signal.

In accordance with another exemplary embodiment of the present disclosure, a user may pre-select the form of the alternative recommendation to have a specific form or content, e.g., as one or more of the above described examples. This pre-selection may be a part of, e.g., a user profile of a user device. That is, e.g., a user may choose a certain type of recommendation such as a generic recommendation or an obscured recommendation to always be used as the alternative recommendation when other people are present. A user may also choose that no alternative recommendation is displayed, so that no information whatsoever is displayed in the presence of other people. In this case, an obscured recommendation means no recommendation sent to the user.

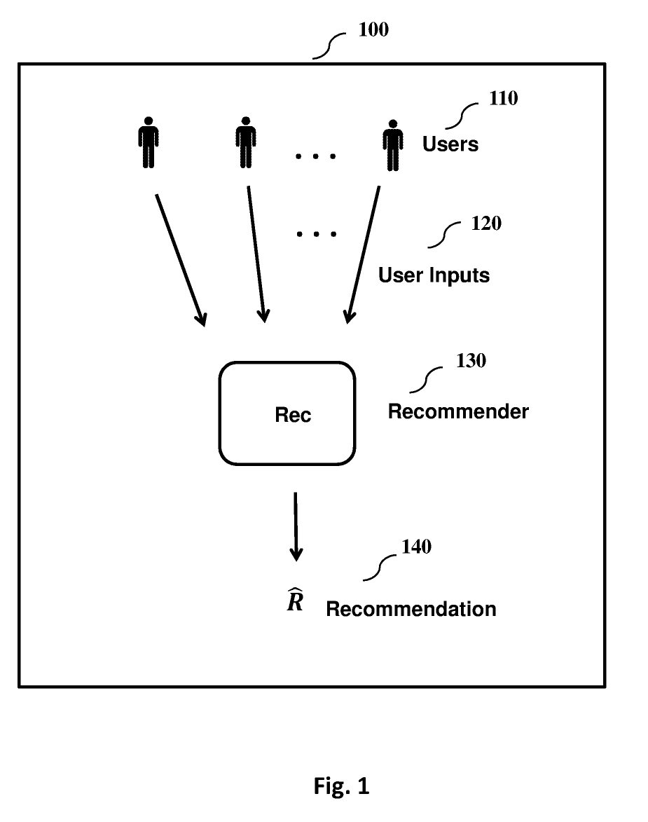

FIG. 1 illustrates the components of a general recommendation system 100 which may be employed according to the present disclosure. As shown in FIG. 1, a number of users 110 are shown which represent a source for providing a plurality of user inputs 120 in the form of, e.g., ratings to items (e.g., movies, products, online services, etc.), personal information, personal preferences, emails, social network interactions, sales information, etc. A processor (not shown) in the recommender 130 processes the users' inputs 120 through various different techniques and algorithms as are well known in the art and outputs recommendations 140 for one or more users.

As mentioned above, and to be described further below, if the recommendation system 100 determines that there is at least one other person present besides the normal or the usual user (e.g., the owner) of a user device, then the recommendation system will provide an alternative recommendation instead of the usual personalized recommendation in accordance with the present disclosure.

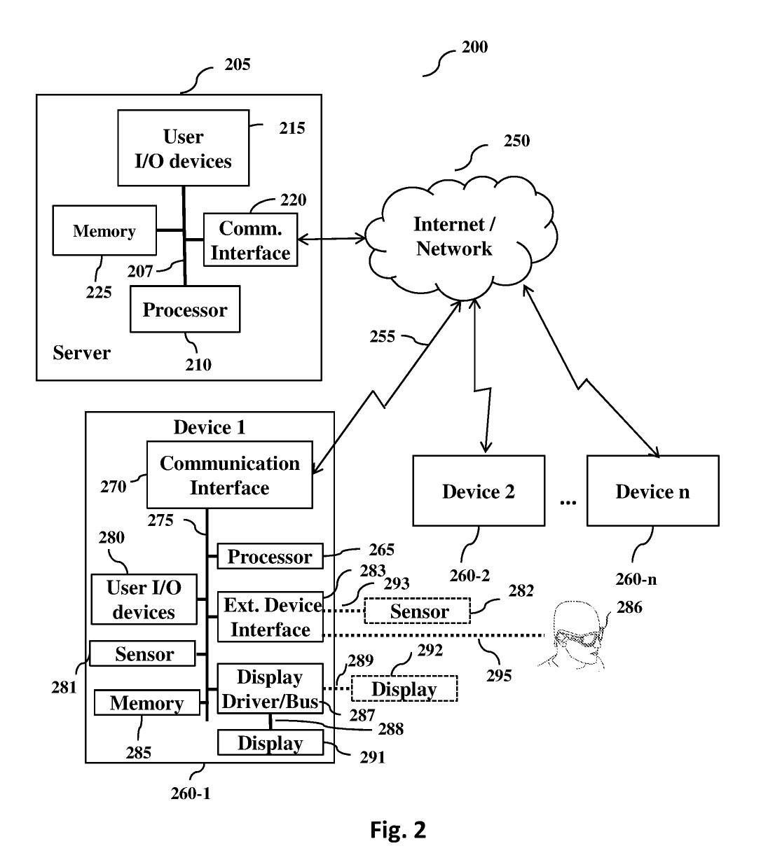

FIG. 2 shows another exemplary system according to the present disclosure. For example, a system 200 in FIG. 2 includes a server or service provider 205 which is capable of receiving and processing user requests and/or user rating data from one or more of user devices 260-1 to 260-n. The server 205 may be, for example, a content server. The content server, in response to a user request for content, provides program content comprising various multimedia assets such as, but not limited to, movies or TV shows for viewing, streaming or downloading by users using the devices 260-1 to 260-n. The content server 205 also provides a user recommendation based on the user rating data provided by the user or the user's consumption or viewership history or behavior. As noted above, the user recommendation may be a personalized recommendation or an alternative recommendation of multimedia programs to a user in the case when other people are present. The alternative recommendation may be a generic recommendation or a recommendation that is obscured, as noted above and also to be described further below. As noted above, the server or service provider may provide other services besides content delivery.

Various exemplary user devices 260-1 to 260-n in FIG. 2 may communicate with the exemplary server 205 over a communication network 250 such as the Internet, a wide area network (WAN), and/or a local area network (LAN). Server 205 may communicate with user devices 260-1 to 260-n in order to provide and/or receive relevant information such as recommendations, user ratings, metadata, web pages, media contents, sales offers, sales requests, etc., to and/or from user devices 260-1 to 260-n thru the network connections. Server 205 may also provide additional processing of information and data when the processing is not available and/or capable of being conducted on the local user devices 260-1 to 260-n. As an example, server 205 may be a computer having a processor 210 such as, e.g., an Intel processor, running an appropriate operating system such as, e.g., Windows 2008 R2, Windows Server 2012 R2, Linux operating system, etc. According to the present disclosure, processor 210 may execute software to perform the recommender function as shown in FIG. 1 and described above.

User devices 260-1 to 260-n shown in FIG. 2 may be one or more of but are not limited to, e.g., a PC, a laptop, a tablet, a cell phone, a smart phone, a smart watch, a video receiver, a smart television (TV), or the like. An example of such devices may be, e.g., a Microsoft Windows 10 computer/tablet/laptop, an Android phone/tablet, an Apple IOS phone/tablet, a TV receiver, or the like. A detailed block diagram of an exemplary user device according to the present disclosure is illustrated in block 260-1 of FIG. 2 as Device 1, and is further described below. Similar components and features may also be present in the other user devices in FIG. 2.

An exemplary user device 260-1 in FIG. 2 comprises a processor 265 for processing various data and for controlling various functions and components of the device 260-1, including video encoding/decoding and processing capabilities in order to play, display, and/or transport video content. The processor 265 communicates with and controls the various functions and components of the device 260-1 via a control bus 275, as shown in FIG. 2.

Device 260-1 may also comprise a display 291 which is driven by a display driver/bus component 287 under the control of processor 265 via a display bus 288, as shown in FIG. 2. The display 291 may be a touch display. In addition, the type of the display 291 may be, e.g., LCD (Liquid Crystal Display), LED (Light Emitting Diode), OLED (Organic Light Emitting Diode), etc. In addition, an exemplary user device 260-1 according to the present disclosure may have its display outside of the user device, or an additional or a different external display may be used to display the content provided by the display driver/bus component 287. This is illustrated, e.g., by an exemplary external display 292 which is connected to an external display connection 289 of device 260-1 of FIG. 2. The connection may be a wired or a wireless connection.

In addition, exemplary device 260-1 in FIG. 2 may also comprise user input/output (I/O) devices 280. The user I/O or interface devices 280 of the exemplary device 260-1 may represent e.g., a mouse, touch screen capabilities of a display (e.g., display 291 and/or 292), a touch and/or a physical keyboard for inputting user data. The user interface devices 280 of the exemplary device 260-1 may also comprise a speaker or speakers, and/or other user indicator devices, for outputting visual and/or audio sound, user data and feedback.

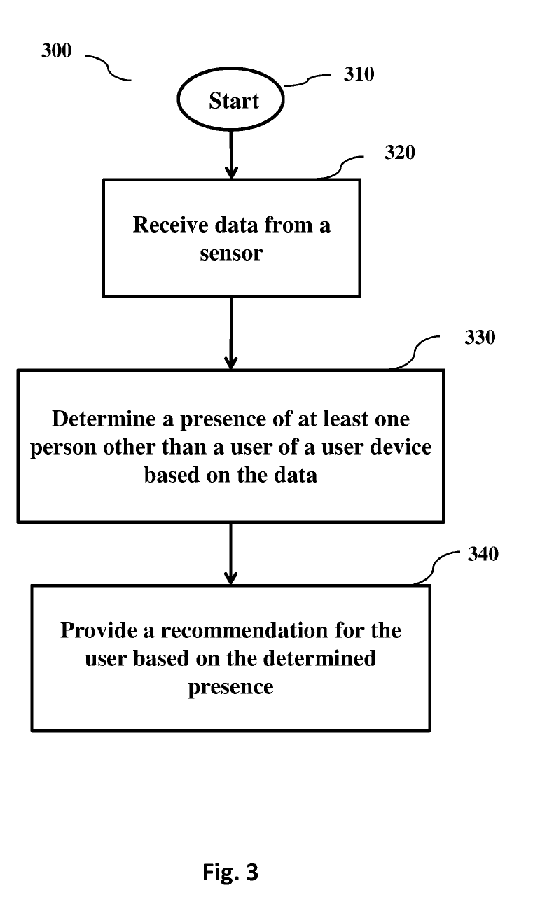

Exemplary device 260-1 also comprises a memory 285 which may represent at least one of a transitory memory such as Random Access Memory (RAM), and a non-transitory memory such as a Read-Only Memory (ROM), a hard drive, a Compact Disk (CD) drive, a Blu-ray drive, and/or a flash memory, for processing and storing different files and information as necessary, including computer program products and software (e.g., as represented by a flow chart diagram of FIG. 3 to be discussed below), webpages, user interface information, databases, etc., as needed. In addition, device 260-1 also comprises a communication interface 270 for connecting and communicating to/from server 205 and/or other devices, via, e.g., the network 250 using the link 255 representing, e.g., a connection through a cable network, a FIOS network, a Wi-Fi network, and/or a cellphone network (e.g., 3G, 4G, LTE, 5G), etc.

According to the present disclosure, an exemplary device 260-1 in FIG. 2 may also comprise a sensor 281 configured to detect presence of persons within a vicinity of the user device 260-1. In particular, sensor 281 is configured to detect, in conjunction with processor 265, the presence of another person besides the user of the device 260-1. In an exemplary embodiment, sensor 281 may be at least an audio sensor such as a microphone, a visual sensor such as a camera, and/or other types of sensors as to be described further below.

As shown in FIG. 2, an exemplary people presence detection sensor 281 may be located inside the user device 260-1. In another non-limiting embodiment according to the present disclose, an exemplary external sensor 282 may be separate from the user device 260-1 (e.g., placed in the room walls, ceiling, doors, inside another device, etc.). The exemplary external sensor 282 may have a wired or wireless connection 293 to the device 260-1 via an external device interface 283 of the device 260-1, as shown in FIG. 2.

In accordance with the present disclosure, different types of sensors for people detection may be used. For example, the detection sensors may be visual sensors such as cameras, or audio sensors such as microphones, as mentioned above. As illustrated in FIG. 2, for example, visual data from a camera sensor (e.g., 281 or 282 of FIG. 2) may be provided to processor 265 of user device 260-1 via processor bus 275 for further processing. In particular, processor 265 may use well-known facial recognition techniques or algorithms to determine if other people besides the user are also detected in the imaging area covered by the camera sensor 281 or 282 of FIG. 2. Examples of well-known facial recognition algorithms include, e.g., Principal Component Analysis using eigenfaces, Linear Discriminate Analysis, Elastic Bunch Graph Matching using the Fisherface algorithm, the Hidden Markov model, the Multilinear Subspace Learning using tensor representation, and the neuronal motivated dynamic link matching. In the facial recognition detection scenario, the normal or the usual user (e.g., owner) of the user device 260-1 creates a user profile with a picture of image of his or her face so that the facial recognition technique or algorithm employed may readily distinguish the user normally or usually associated with the user device over the other people also present in the vicinity of the user device 260-1. In one embodiment, the user may also provide pictures or images of the faces of other people in his or her circle of friends, family and/or co-workers to enhance the performance of the facial recognition technique for this particular user.

In another exemplary embodiment, voice recognition instead of, or in addition to, facial recognition may be employed to determine the presence of persons within the detection area of an audio sensor such as a microphone. Similarly, well-known voice recognition techniques or algorithms may be employed by processor 265 to process audio or voice data detected and picked up by an exemplary audio sensor (e.g., 281 or 282 of FIG. 2) in order to determine whether other people are also present in the vicinity of the user device 260-1. Examples of well-known techniques used to process and store voice prints include frequency estimation, hidden Markov models, Gaussian mixture models, pattern matching algorithms, neural networks, matrix representation, Vector Quantization and decision trees. Again, the normal or the usual user associated with the user device 260-1 creates a personal voice recording so that processor 265 may recognize and distinguish the owner of the device 260-1 from other people which may also be present in the vicinity of the user device 260-1. In one embodiment, the user may also provide voice recordings of other people in his or her circle of friends, family and/or co-workers to enhance the performance of the voice recognition technique for this particular user.

In accordance with the present disclosure, other exemplary sensors may also be deployed to detect the presence of people other than the user in the proximity of a user device. An example of such sensors may be, e.g., a Radio Frequency Identification (RFID) tag (or tracking tags, or wearables) of a person other than the user which may come within a vicinity of the user device and may be used to identify that person. As is well known in the art, RFID uses radio waves to automatically identify people or objects. There are several methods of identification, but the most common is to store a serial number that identifies a person or object, and perhaps other information, on a microchip that is attached to a radio frequency antenna (i.e., the microchip and the antenna together are called an RFID transponder or an RFID tag). The antenna enables the microchip to transmit the identification information to a RFID reader. The RFID reader converts the radio waves reflected back from the RFID tag into digital information that can then be passed on to, e.g., a processor 265 of the user device 260-1 shown in FIG. 2 so that different people within the area of the user device 260-1 may be identified.

In addition, other sensors may be used to monitor a respective electronic connection or activity of a person or a person's device in a room or on a network. Such an exemplary person identity sensor may be, e.g., a Wi-Fi router which keeps track of different devices or logins on the network served by the Wi-Fi router, or a server which keeps track of logins to emails or online accounts being serviced by the server. In addition, other exemplary sensors may be location based sensors such as GPS and/or Wi-Fi location tracking sensors in conjunction with applications commonly found on mobile devices and apps such as Google Maps app on an Android mobile device that identifies the respective locations of the users. Furthermore, other exemplary sensors may be motion sensors (e.g., Passive Infrared, PIR, sensors, ultrasound sensors, thermal imaging sensors, systems like Microsoft Kinectic, break beams, etc.), wearable microphones, wearable cameras, etc.

In another non-limiting exemplary embodiment in accordance with the present disclosure, as shown in FIG. 2, if processor 265 detects that a virtual reality (VR) or an augmented reality (AR) glasses 286 (such as, e.g., Oculus Rift (from Oculus VR), PlayStation VR (from Sony), Gear VR (from Samsung), Google Glass (from Google), etc.) is attached to the user device 260-1 via the external device interface 283 through a connection 295 and is being utilized by the user, the user device 260-1 will automatically assume that the user is a private setting since no other person can see the recommendation being displayed on the private screen(s) of the AR or VR glasses. Therefore, the provided recommendation will automatically be defaulted to a personalized recommendation when a VR or AR glasses is being used. The user may be identified by, e.g., eye (e.g., iris) recognition or by entering a password in order to use the glasses. Continuing with FIG. 2, exemplary user devices 260-1 to 260-n may access different media assets, recommendations, web pages, services or databases provided by server 205 using, e.g., Hypertext Transfer Protocol (HTTP). A well-known web server software application which may be run by server 205 to service the HTTP protocol is Apache HTTP Server software. Likewise, examples of well-known media server software applications for providing multimedia programs include, e.g., Adobe Media Server and Apple HTTP Live Streaming (HLS) Server. Using media server software as mentioned above and/or other open or proprietary server software, server 205 may provide media content services similar to, e.g., Amazon, Netflix, or M-GO as noted before. Server 205 may also use a streaming protocol such as e.g., Apple HTTP Live Streaming (HLS) protocol, Adobe Real-Time Messaging Protocol (RTMP), Microsoft Silverlight Smooth Streaming Transport Protocol, etc., to transmit various programs comprising various multimedia assets such as, e.g., movies, TV shows, software, games, electronic books, electronic magazines, etc., to the end-user device 260-1 for purchase and/or viewing via streaming, downloading, receiving or the like.

FIG. 2 also illustrates further details of an exemplary server or service provider 205. Server 205 comprises a processor 210 which controls the various functions and components of the server 205 via a control bus 207 as shown in FIG. 2. Server 205 also comprises a memory 225 which may represent at least one of a transitory memory such as RAM, and a non-transitory memory such as a ROM, a hard drive, a CD Rom drive or a Blu-ray drive, and/or a flash memory, for processing and storing different files and information as necessary, including computer program products and software, webpages, user interface information, user profiles, user recommendations, user ratings, metadata, electronic program listing information, databases, search engine software, etc., as needed. Search engine and recommender software according to the present disclosure may be stored in the non-transitory memory 225 of server 205, as necessary, so that media recommendations may be provided, e.g., in response to a user's profile and rating of disinterest and/or interest in certain media assets, and/or for searching using criteria that a user specifies using textual input (e.g., queries using “sports”, “adventure”, “Angelina Jolie”, etc.).

In addition, a server administrator may interact with and configure server 205 to run different applications using different user input/output (I/O) devices 215 as well known in the art. The user I/O or interface devices 215 of the exemplary server 205 may represent e.g., a mouse, touch screen capabilities of a display, a touch and/or a physical keyboard for inputting user data. The user interface devices 215 of the exemplary server 205 may also comprise a speaker or speakers, and/or other user indicator devices, for outputting visual and/or audio sound, user data and feedback.

Furthermore, server 205 may be connected to network 250 through a communication interface 220 for communicating with other servers or web sites (not shown) and one or more user devices 260-1 to 260-n, as shown in FIG. 2. The communication interface 220 may also represent television signal modulator and RF transmitter in the case when the content provider 205 represents a television station, cable or satellite television provider. In addition, one skilled in the art would readily appreciate that other well-known server components, such as, e.g., power supplies, cooling fans, etc., may also be needed, but are not shown in FIG. 2 to simplify the drawing.

In one non-limiting exemplary embodiment of the present disclosure, the sensor or sensors 281, 282, 286 may also be connected to the server or service provider 205 by wired (e.g., Ethernet cable) or wireless (e.g., 802.11 standards or Bluetooth) means (e.g., LAN or WAN network) and processor 210 may remotely perform the operation of detecting the presence of a person other than the user.

FIG. 3 illustrates a flowchart 300 of an exemplary method according to the present disclosure. The method starts at step 310. The method includes, at step 320, receiving data from at least one sensor. As noted above, the sensor or sensors may be one or more of different exemplary types of sensors which have already been described in detail in connection with FIG. 2. Next, at step 330, the method includes determining a presence of at least one person other than a user of a user device based on the data. Finally, at step 340, the method includes providing a recommendation for the user based on the determined presence.

In some embodiments of the present disclosure, the determination of the presence of at least one other person in step 330, may be a function of one of more of the following factors/features listed below:
Whether the at least one other person is within a distance from the user device—that is, a distance threshold from the user device may be established so that, even though a person is detected, but if the person is beyond the established threshold, then the person is considered as not present. This is because beyond a certain distance, a recommendation on the user device may be difficult or impossible to see. The distance of a person detected by e.g., a camera, may be determined by well-known techniques such as, e.g., by using triangle similarity to calculate the distance of the detected person. In another exemplary embodiment, the distance may be determined based on how loud a detected voice is, as the voice is picked up by a microphone sensor.
A size of a screen of the user device—that is, the larger the screen, the easier for other persons to be able to see the recommendation on the screen. Therefore, the distance detection threshold, as noted above, may also be changed as a function of the size of the screen.
A type of recommendation—that is, e.g., a recommendation may comprise an image, a video, audio and/or text. Visual and audio recommendations may be more easily understood. Text may be more difficult to see beyond a certain distance. Therefore, the distance threshold described above may also be modified as a function of the type of the recommendation.
Whether the at least one person is facing a screen of the user device—that is, if a person is facing another direction (e.g., away from the screen of the user device), there is no need to de-personalize or obscure the recommendation. This may be determined e.g., by using facial recognition as described above in connection with FIG. 2.
Whether the at least one person is known by the user—that is, the user of the device may not mind sharing a personalized recommendation with other people to whom he or she is closely related or connected with such as, e.g., a spouse, or a friend on one of social networks on the Internet.
A movement of the person in a vicinity of the user device—that is, whether the person is moving in the direction of the device or away from the device, or passing by laterally to the device. As well known in the art, tracking the movement of a person may also be done with cameras. The movement detection may also be done using sound sensors (which detect the amplitude and direction of the voice or noise), as well as radar or infrared detectors.

According to one embodiment of the present disclosure, a personalized recommendation is provided if no presence is determined at step 330, and an alternative recommendation is provided when there is a determined presence at step 330. Again, an alternative recommendation may be, e.g., a generic and/or an obscured recommendation as described above.

According to some embodiments of the present disclosure, a user of a user device may have other personal restrictions or desire for customizing the recommendation. For example, a user may not mind that a family member sees his or her recommendations but would mind if a co-worker or a stranger sees the recommendations. Alternatively, for example, a user may not mind that a total stranger in a public place (e.g., an airport or a restaurant) may see the user's screen, but would mind if a co-worker or even a family member sees the personalized recommendation. Therefore, according to the present disclosure, a type of recommendation customization may be performed as further described below.

For example, in one embodiment, determining whether another person is known by the user or permitted to see a personalized recommendation may be based on, e.g., different forms of social network activities on different social networks of the Internet (e.g., Facebook, Twitter, LinkedIn, etc.) as already noted above. In another exemplary embodiment, the user may accept synchronizing his or her social networks with the recommendation provider or recommender, or the recommender may be itself a social network provider.

In another embodiment, determining whether another person is known by the user or is permitted to see a personalized recommendation may be based on information provided by the user. For example, the user may provide a blacklist of people which are prohibited to see the personalized recommendation of the user. Once the blacklist is created, the method 300 (or exemplary user device 260-1, or user 205, of FIG. 2) determines whether any of the people on the blacklist has been detected by the people identification and detection methods as described above. If any of the prohibited people has been detected, then an alternative recommendation is provided instead of the personalized recommendation. In another embodiment, a person may be determined to have connection with the user of the device when the same person has already been previously detected for a certain number of times (e.g., one time). In another embodiment, the status of the person detected is determined based on a combination of the above described factors.

Also, as already described above, according to one embodiment, the determination of the presence of at least one other person may be performed by a user device (e.g., exemplary user device 260-1 of FIG. 2). In accordance with an exemplary embodiment of the present disclosure, once a determination of the presence of another person besides the user of the user device is made, the user device may send an indication such as e.g., a flag to the recommender (e.g., residing in server 205 of FIG. 2) in real-time. The exemplary flag may indicate as to whether or not an alternative recommendation instead of a personalized recommendation should be provided by the recommender (e.g., server 205). For example, if the flag is ‘0’, the recommender may send the personalized recommendation to the user device, and if the flag is ‘1’, the recommender may provide an alternative recommendation instead, or vice versa. In another alternative embodiment according to the present disclosure, the recommender may provide both the personalized and alternative versions of the recommendations to the user device, and the user device may then adaptively provide the display of one or the other version based on the presence determination.

In another embodiment, a user device (e.g., user device 260-1) may be co-located with another second device (e.g., user device 260-2 as shown in FIG. 2). Both devices may belong to the same user, or the second device may belong to the recommender. The sensor(s) may be included or connected to the user device, or to the second device. The sensor(s) may also be a device like the second device, including a processor, memories, I/O interfaces, etc. The step of determining 330 may be performed by the user device, by the recommender or by the second device. In the exemplary scenario, one or more sensors (e.g., 281 or 282 of device 260-1) may provide sensor data to the second device 260-2 and the second device may perform the step of determining 330. Alternatively, the user device may provide the determination result of the people presence determination directly to the second device and the second device provides the recommendation 340. These data and results may be provided in real-time, or intermittently. In another exemplary embodiment, the remotely located service provider may provide the presence determination based on account logins, IP addresses, GPS and/or Wi-Fi locator capabilities, or sensor data received from the user device or from the second device, to determine whether other people besides the user of the user device are present in a vicinity of the user device as described above. Therefore, according to the present disclosure, one device or service may provide sensor data and/or presence determination to another device or service. As a result, the steps of the method 300 according to the present disclosure may be performed in a distributed or centralized way, by one or more devices, the devices being a user device, a second device (belonging to a user or a service provider) or a recommender (or server or service provider) device.

According to one non-limiting embodiment of the present disclosure, a user may select the various sensory or presence determination options described above during a sign-up process with the recommendation provider or recommender (e.g., server 205). For example, a user may be asked if the user wants to activate, e.g., an “anonymous recommendation with other people present” feature. Once the user approves and selects the desired feature and configuration, the service provider may acquire control of at least one sensor inside or connected to the user device, as described above.

In another non-limiting embodiment according to the present disclosure, the de-personalization or obscuring of the recommendation may be disabled by the user, either by a setting, or by not downloading a downloadable software program to perform the determination of a presence, or by disabling the software and/or hardware that performs the determination of a presence, or by refusing to give control of sensors to a second device. The user may also be prompted to maintain personalized recommendation or obscure it. Several of the features may be provided in settings of the system or by asking the user during the interaction with the recommender of a service provider.

In yet another non-limiting embodiment according to the present disclosure, a personalized recommendation may still be kept private to a user of a user device (e.g., user device 260-1 of FIG. 2), even if another person is detected to be present by transferring the personalized recommendation to another device. For example, if the recommender (e.g., of the service provider 205) is aware of another device of the user with a smaller screen (e.g., 260-2 or 260-n) such as a cell phone is nearby, the recommender may send the still personalized recommendation to the smaller screen device, which may be harder for other people to see. In another exemplary embodiment, the personalized recommendation may be changed to another format. For example, it may be sent as a text only message. It may also be changed to a Uniform Resource Locator (URL) pointing to a website for later access of the personalized recommendation by the user, as noted above.

In the present disclosure, the step of receiving associated with flowchart 300 can imply receiving, accessing or retrieving. The step of providing associated with flowchart 300 can imply outputting, transmitting or storing in memory for later access or retrieval.

It is to be understood that any of the methods of the present disclosure can be implemented in various forms of hardware, software, firmware, special purpose processors, or a combination thereof. The present disclosure can be implemented as a combination of hardware and software. Moreover, the software can be implemented as an application program tangibly embodied on a program storage device. The application program can be uploaded to, and executed by, a machine comprising any suitable architecture. The machine can implemented on a computer platform having hardware such as one or more central processing units (CPU), a random access memory (RAM), and input/output (I/O) interface(s). The computer platform also includes an operating system and microinstruction code. The various processes and functions described herein can either be part of the microinstruction code or part of the application program (or a combination thereof), which is executed via the operating system. In addition, various other peripheral devices can be connected to the computer platform such as an additional data storage device and a printing device.

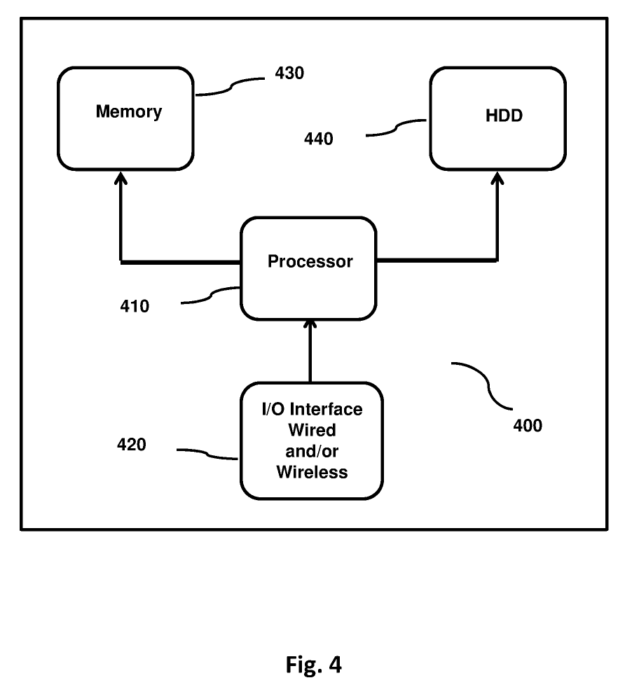

FIG. 4 illustrates a block diagram of an exemplary computing environment 400 within which any of the methods of the present disclosure can be implemented and executed. The computing environment 400 includes a processor 410, and at least one (and preferably more than one) I/O interface 420. The I/O interface 420 can be wired or wireless and, in the wireless implementation is pre-configured with the appropriate wireless communication protocols to allow the computing environment 400 to operate on a global network (e.g., internet) and communicate with other computers or servers (e.g., cloud based computing or storage servers) so as to enable the present disclosure to be provided, for example, as a Software as a Service (SAAS) feature remotely provided to end users. One or more memories 430 and/or storage devices (Hard Disk Drive (HDD)) 440 are also provided within the computing environment 400. The computing environment can be used to implement a node or device, and/or a controller or server that operates the storage system. The computing environment can be, but is not limited to, desktop computers, cellular phones, smart phones, phone watches, tablet computers, personal digital assistant (PDA), netbooks, laptop computers, set-top boxes or general multimedia content receiver and/or transmitter devices. The computer environment can be any of the devices illustrated in FIG. 2, including devices 260-1, 260-2, 260-n and 205.

Furthermore, aspects of the present disclosure can take the form of a computer-readable storage medium. Any combination of one or more computer-readable storage medium(s) can be utilized. A computer-readable storage medium can take the form of a computer-readable program product embodied in one or more computer-readable medium(s) and having computer-readable program code embodied thereon that is executable by a computer. A computer-readable storage medium as used herein is considered a non-transitory storage medium given the inherent capability to store the information therein as well as the inherent capability to provide retrieval of the information therefrom. A computer-readable storage medium can be, for example, but is not limited to, an electronic, magnetic, optical, electromagnetic, infrared, or semiconductor system, apparatus, or device, or any suitable combination of the foregoing.

It is to be appreciated that the following list, while providing more specific examples of computer-readable storage mediums to which the present disclosure can be applied, is merely an illustrative and not exhaustive listing as is readily appreciated by one of ordinary skill in the art. The list of examples includes a portable computer diskette, a hard disk, a read-only memory (ROM), an erasable programmable read-only memory (EPROM or Flash memory), a portable compact disc read-only memory (CD-ROM), an optical storage device, a magnetic storage device, or any suitable combination of the foregoing.

According to one aspect of the present disclosure, a method of providing a recommendation is provided including receiving data from at least one sensor, determining a presence of at least one person other than a user of a user device based on the data, and providing a recommendation for the user based on the determined presence.

According to one embodiment of the method, the at least one sensor is at least one of a camera and a microphone.

According to one embodiment of the method, the at least one sensor is configured to detect a network activity of the at least one person other than the user.

According to one embodiment of the method, the at least one sensor is located in the user device.

According to one embodiment of the method, the at least one sensor is connected to the user device.

According to one embodiment of the method, the determining a presence includes determining whether the at least one other person is within a distance from the user device.

According to one embodiment of the method, the determining a presence is based on a size of a screen of the user device.

According to one embodiment of the method, the determining a presence is based on a type of recommendation.

According to one embodiment of the method, the determining a presence is based on whether the at least one person is facing a screen of the user device.

According to one embodiment of the method, the determining a presence is based on whether the at least one person is known by the user.

According to one embodiment of the method, whether a person is known by the user is identified by at least one social network connection on the internet.

According to one embodiment of the method, whether a person is known by the user is identified by being previously detected in a vicinity of the user device.

According to one embodiment of the method, the determining a presence is based on a movement of the person in a vicinity of the user device.

According to one embodiment of the method, the providing further includes providing a first recommendation if no person other than the user is determined to be present.

According to one embodiment of the method, the first recommendation is a personalized recommendation.

According to one embodiment of the method, the providing further includes providing a second recommendation if at least one person other than the user is determined to be present.

According to one embodiment of the method, the second recommendation is one of a generic or obscured recommendation.

According to one embodiment of the method, the second recommendation is one of customized or pre-selected by the user.

According to one embodiment of the method, the providing further includes generating a flag based on the determined presence; and receiving the recommendation based on the flag.

According to one embodiment of the method, the method further includes generating the recommendation based on the determined presence.

According to one embodiment of the method, the recommendation is at least one of text, video and audio.

According to one embodiment of the method, the method further includes transferring the recommendation to another device prior to providing the recommendation.

According to one embodiment of the method, the method further includes changing a type of recommendation prior to the transferring.

According to one aspect of the present disclosure, an apparatus for providing a recommendation is provided including a processor in communication with at least one input/output interface, and at least one memory in communication with the processor, the processor being configured to perform any of the embodiments of the method of zooming video content.

According to one aspect of the present disclosure, an apparatus for providing a recommendation is provided including a processor in communication with at least one input/output interface for executing a set of instructions, and at least one memory in communication with the processor, said memory storing the set of instructions that when executed cause the processor to perform any of the embodiments of the method of zooming video content.

According to one aspect of the present disclosure, a computer-readable storage medium carrying a software program is provided including program code instructions for performing any of the embodiments of the method of providing a recommendation.

According to one aspect of the present disclosure, a computer program product stored in a non-transitory computer-readable storage medium is provided including computer-executable instructions for performing any of the embodiments of the method of providing a recommendation when the program is executed by a computer.

As noted before, the functions of the various elements shown in the figures may be provided through the use of dedicated hardware as well as hardware capable of executing software in association with appropriate software. Also, when provided by a processor, the functions may be provided by a single dedicated processor, by a single shared processor, or by a plurality of individual processors, some of which may be shared.

It is to be further understood that, because some of the constituent system components and methods depicted in the accompanying drawings are preferably implemented in software, the actual connections between the system components or the process function blocks may differ depending upon the manner in which the present disclosure is programmed. Given the teachings herein, one of ordinary skill in the pertinent art will be able to contemplate these and similar implementations or configurations of the present disclosure.

Although the illustrative embodiments have been described herein with reference to the accompanying drawings, it is to be understood that the present disclosure is not limited to those precise embodiments, and that various changes and modifications may be effected therein by one of ordinary skill in the pertinent art without departing from the scope of the present disclosure. In addition, individual embodiments can be combined, without departing from the scope of the present disclosure. All such changes and modifications are intended to be included within the scope of the present disclosure as set forth in the appended claims.

1. A method of providing a recommendation comprising:
receiving data from at least one sensor;
determining a presence of at least one person other than a user of a user device based on the data; and
providing a recommendation for the user based on the determined presence.

2. The method of claim 1 wherein the at least one sensor is at least one of a camera and a microphone.

3. The method of claim 1 wherein the at least one sensor is configured to detect a network activity of the at least one person other than the user.

4. The method of claim 1 wherein the at least one sensor is located in the user device.

5. The method of claim 1 wherein the at least one sensor is connected to the user device.

6. The method of claim 1 wherein the determining a presence comprises:
determining whether the at least one other person is within a distance from the user device.

7. The method of claim 1 wherein the determining a presence is based on a size of a screen of the user device.

8. The method of claim 1 wherein the determining a presence is based on a type of recommendation.

9. The method of claim 1 wherein the determining a presence is based on whether the at least one person is facing a screen of the user device.

10. The method of claim 1 wherein the determining a presence is based on whether the at least one person is known by the user.

11-23. (canceled)

24. An apparatus for providing a recommendation comprising:
a processor in communication with at least one input/output interface; and
at least one memory in communication with the processor, the processor being configured to:
receive data from at least one sensor;
determine a presence of at least one person other than a user of a user device based on the data; and
provide a recommendation for the user based on the determined presence.

25. The apparatus of claim 24 wherein the at least one sensor is at least one of a camera and a microphone.

26. The apparatus of claim 24 wherein the at least one sensor is configured to detect a network activity of the at least one person other than the user.

27. The apparatus of claim 24 wherein the at least one sensor is located in the user device.

28. The apparatus of claim 24 wherein the at least one sensor is connected to the user device.

29. The apparatus of claim 24 wherein the presence is determined based on whether the at least one other person is within a distance from the user device.

30. The apparatus of claim 24 wherein the presence is determined based on a size of a screen of the user device.

31. The apparatus of claim 24 wherein the presence is determined based on a type of recommendation.

32. The apparatus of claim 24 wherein the presence is determined based on whether the at least one person is facing a screen of the user device.

33. The apparatus of claim 24 wherein the presence is determined based on whether the at least one person is known by the user.

34-46. (canceled)
